(19) United States
(12) Patent Application Publication
(10) Pub. No.: US 2026/0280644 A1
(43) Pub. Date: Sep. 17, 2026

(54) TECHNIQUES FOR INDICATING A CSI FEEDBACK RESTRICTION

(71) Applicant: Lenovo (Singapore) Pte. Ltd., Singapore (SG)

(72) Inventors: Ahmed Hindy, Aurora, IL (US); Vahid Pourahmadi, München (DE); Venkata Srinivas Kothapalli, Ottawa (CA); Vijay Nangia, Woodridge, IL (US)

(21) Appl. No.: 19/470,694

(22) PCT Filed: Apr. 1, 2024
(86) PCT No.: PCT/IB2024/000173

§ 371 Date: Sep. 29, 2025

Related U.S. Application Data
(60) Provisional application No. 63/493,651, filed on Mar. 31, 2023.

(51) Int. Cl. H04B 7/06

(52) U.S. Cl. CPC H04B 7/0626; H04B 7/0639

(57) ABSTRACT

Apparatuses, methods, and systems are disclosed for PSFCH priority determination. One UE includes a processor coupled with a memory and configured to cause the UE to receive a channel state information (CSI) reporting setting comprising an indication of a codebook subset restriction (CBSR) associated with a precoding matrix and receive a non-zero power (NZP) CSI reference signal (CSI-RS) based on the CSI reporting setting. The processor is further configured to cause the UE to generate a CSI report comprising a precoding matrix indicator (PMI) value based on the NZP CSI-RS and the CBSR and to transmit the CSI report comprising the PMI value.

### TECHNICAL FIELD

The present disclosure relates to wireless communications, and more specifically to techniques for signaling precoder restrictions for channel state information (CSI) feedback.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for receiving a CSI reporting setting comprising an indication of a codebook subset restriction (CBSR) associated with a precoding matrix. The method and apparatuses described herein may include means for receiving a non-zero power (NZP) CSI reference signal (CSI-RS) based on the CSI reporting setting. The method and apparatuses described herein may include means for generating a CSI report comprising a precoding matrix indicator (PMI) value based on the NZP CSI-RS and the CBSR. The method and apparatuses described herein may include means for transmitting the CSI report comprising the PMI value.

Other implementations of the method and apparatuses described herein may include means for transmitting a CSI reporting setting comprising an indication of a CBSR associated with a precoding matrix. The method and apparatuses described herein may include means for transmitting a NZP CSI-RS based on the CSI reporting setting. The method and apparatuses described herein may include means for receiving a CSI report comprising a PMI value based on the NZP CSI-RS and the CBSR.

### BRIEF DESCRIPTION OF THE DRAWINGS

FIG. 1 illustrates an example of a wireless communication system in accordance with aspects of the present disclosure.

FIG. 2 illustrates an example of a protocol stack showing different protocol layers in the UE and network, in accordance with aspects of the present disclosure.

FIG. 3 illustrates an example of an aperiodic (AP) trigger state that defines a list of CSI reporting settings in accordance with aspects of the present disclosure;

FIG. 4A illustrates an example of an abstract syntax notation one (ASN.1) representation of an aperiodic trigger state that indicates the resource set and quasi-co-location (QCL) information in accordance with aspects of the present disclosure;

FIG. 4B illustrates an example of an ASN.1 representation of a CSI resource configuration associated with the aperiodic trigger state of FIG. 4A in accordance with aspects of the present disclosure;

FIG. 5A illustrates an example of an ASN.1 representation of a radio resource control (RRC) configuration for NZP CSI-RS resources in accordance with aspects of the present disclosure;

FIG. 5B illustrates an example of an ASN.1 representation of an RRC configuration for CSI for interference measurement (CSI-IM) resources in accordance with aspects of the present disclosure;

FIG. 6A illustrates an example CSI report generation in accordance with aspects of the present disclosure;

FIG. 6B illustrates an example partial CSI omission and reordering for physical uplink shared channel (PUSCH) based CSI in accordance with aspects of the present disclosure;

FIG. 7 illustrates an example of an ASN.1 representation of a CSI reporting setting information element (IE) in accordance with aspects of the present disclosure;

FIG. 8 illustrates an example of an ASN.1 representation of a codebook configuration IE in accordance with aspects of the present disclosure;

FIG. 9 illustrates an example of an ASN.1 representation of a codebook configuration IE in accordance with aspects of the present disclosure;

FIG. 10 illustrates an example of a UE in accordance with aspects of the present disclosure.

FIG. 11 illustrates an example of a processor in accordance with aspects of the present disclosure.

FIG. 12 illustrates an example of a network equipment (NE) in accordance with aspects of the present disclosure.

FIG. 13 is a flowchart diagram illustrating one embodiment of a method of a UE for indicating a precoder restriction for CSI feedback in accordance with aspects of the present disclosure.

FIG. 14 is a flowchart diagram illustrating one embodiment of a method of a NE for indicating a precoder restriction for CSI feedback in accordance with aspects of the present disclosure.

### DETAILED DESCRIPTION

The present disclosure describes systems, methods, and apparatuses for indicating (e.g., signaling) a precoder restriction for CSI feedback. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

One or more of the network communication devices (e.g., base stations) or the user communication devices (e.g., UEs) may support a precoder restriction for CSI feedback, wherein the network communication devices may indicate the precoder restriction to the user communication devices, and the user communication devices may generate and report CSI feedback in compliance with the indicated precoder restriction.

In Third Generation Partnership Project (3GPP) new radio (NR) networks, CSI feedback in Frequency Division Duplex (FDD) networks is reported by the UE to the network, where the CSI feedback is compressed via transformation of the channel over the spatial domain (SD), frequency domain (FD), or both, with pre-determined sets of spatial- and frequency-basis vectors, respectively. In addition to conventional CSI feedback mechanisms, Artificial Intelligence and/or Machine Learning (AI/ML)-enabled CSI acquisition schemes are considered strong candidates for future generations of 3GPP NR networks. Note that most AI/ML-enabled CSI acquisition schemes would still require some feedback from the UE to the network corresponding to CSI components that cannot be inferred from the AI/ML model, e.g., CSI components that are statistically independent over time, and hence cannot be inferred from the training data.

One important implementation of AI/ML in CSI acquisition is via two-sided models, in which an encoder and decoder of an autoencoder structure are applied in different nodes. Given that, the CSI feedback corresponding to the output of the encoder part may not comprise an explicit structure compared with the standard SD and FD transformations of the legacy codebook designs. One challenge with the lack of structure of AI/ML-based CSI feedback is the applicability of CBSR, i.e., a functionality that allows the network to restrict the codebook design at the UE to avoid specific beamforming directions that would amplify the inter-cell interference at other UEs. In legacy codebook design, the CBSR is in form of restriction of indices of discrete Fourier transform (DFT) beams associated with the DFT-based spatial transformation in legacy NR codebooks.

The below solutions describe a CBSR-like mechanism that is generic with respect to the underlying design of the precoding matrix under AI/ML-based CSI feedback, where the underlying SD transformation is not necessarily based on a DFT transformation.

Various solutions provide an updated CBSR-like approach, wherein a set of pre-configured precoding vectors are shared with the UE, the network node indicating to the UE a subset of the set of pre-configured precoding vectors, such that the subset of precoding vectors correspond to beamforming directions that are configured to be restricted by the UE when designing the precoding matrix.

Also described herein is a restriction metric that is used to compute an interference coefficient based on a candidate precoding vector and the subset of the precoding vectors, wherein the interference coefficient cannot exceed a configured threshold value for each selected precoding vector associated with the CSI feedback.

Aspects of the present disclosure are described in the context of a wireless communications system. Aspects of the present disclosure are further illustrated and described with reference to system diagrams, device diagrams, configuration parameter diagrams, and flowcharts.

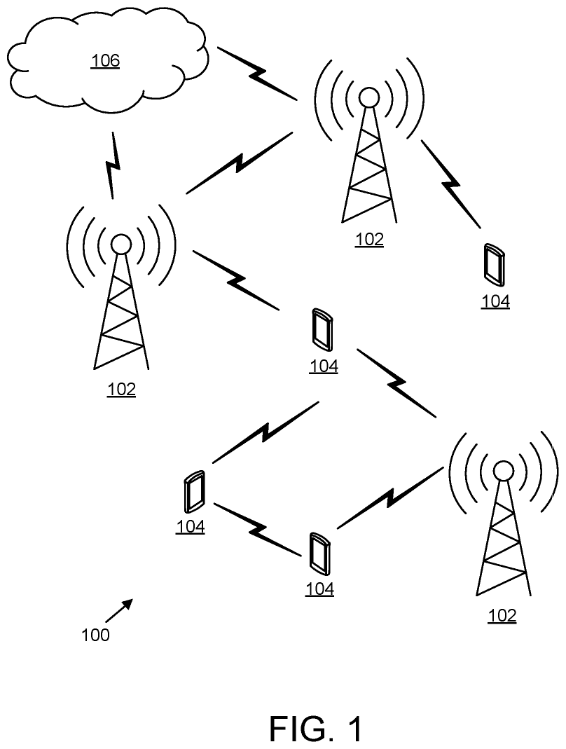

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNB, a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHZ-52.6 GHz), FR3 (7.125 GHZ-24.25 GHz), FR4 (52.6 GHz-114.25 GHz), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., u-3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a synchronization signal block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB.

Note that with beam-based communication, each DL beam may be associated with a respective SSB. In 3GPP NR, the gNB may transmit the maximum 64 SSBs and the maximum 64 corresponding copies of physical downlink control channel (PDCCH) and/or physical downlink shared channel (PDSCH) for delivery of system information block #1 (SIB1) in high frequency bands (e.g., 28 GHz).

In the following, instead of “slot,” the terms “mini-slot,” “subslot,” or “aggregated slots” can also be used, wherein the notion of slot/mini-slot/sub-slot/aggregated slots can be described as defined in 3GPP technical specification (TS) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

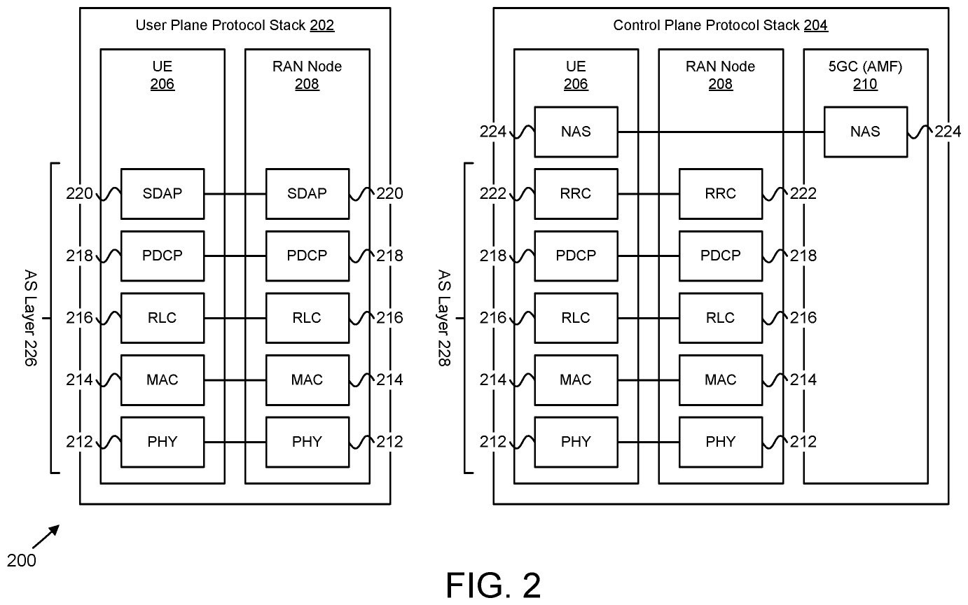

FIG. 2 illustrates an example of a protocol stack 200, in accordance with aspects of the present disclosure. In certain embodiments, the protocol stack 200 is an NR protocol stack for communication between the UE and the mobile network. While FIG. 2 shows a UE 206, a RAN node 208, and a 5GC 210 (e.g., comprising at least an AMF), these are representative of a set of UEs 104 interacting with an NE 102 (e.g., base station) and a CN 106.

As depicted, the protocol stack 200 comprises a user plane (UP) protocol stack 202 and a control plane (CP) protocol stack 204. The UP protocol stack 202 includes a physical (PHY) layer 212, a MAC sublayer 214, a radio link control (RLC) sublayer 216, a packet data convergence protocol (PDCP) sublayer 218, and a service data adaptation protocol (SDAP) layer 220. The CP protocol stack 204 includes a PHY layer 212, a MAC sublayer 214, a RLC sublayer 216, and a PDCP sublayer 218. The Control Plane protocol stack 204 also includes a RRC layer 222 and a NAS layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the protocol stack 200. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

Note that an LTE protocol stack may comprise a similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

In various embodiments, the UE 206 receives a CSI reporting configuration from the RAN node 208 (e.g., a base station unit). As described in greater detail below, the CSI reporting configuration may include a CSI reporting setting that indicates a precoder restriction. Moreover, after receiving a set of channel measurement reference signals including at least one NZP CSI-RS, the UE 206 may generate a CSI feedback report comprising a PMI value derived based on the NZP CSI-RS and the precoder restriction in accordance with the CSI reporting setting. Additionally, the UE 206 transmits the CSI feedback report to the RAN node 208, e.g., over a physical uplink channel.

As discussed above, CBSR is a functionality that allows the network to restrict the CSI codebook design to avoid specific beamforming directions. One option for CBSR-like functionality in future networks is for the network to configure the UE with a CBSR framework that resembles the Type-I CBSR format with hard CBSR restriction or Type-II CBSR with soft CBSR restriction. As used herein, a “hard” amplitude restriction indicates that the amplitude is restricted to a value of zero (i.e., the vector component is not transmitted), whereas a “soft” amplitude restriction indicates the amplitude is restricted to a value of zero or a value below one (i.e., assuming that value one is the reference value). However, the legacy CBSR is in the form of a restriction of column vectors of a DFT-based matrix. Under AI/ML-based CSI feedback, the underlying precoding matrix structure may not comprise a DFT basis corresponding to the SD, and hence a straightforward application of CBSR to the precoding matrix may not be possible with AI/ML-based CSI feedback.

Another option for CBSR-like functionality in future networks is for the network to configure the UE with an arbitrary set of restricted precoding vectors. For example, for a set of K restricted precoding vectors of length N, the network may signal, i.e., to the UE, 2K×N coefficients comprising K×N amplitude values and K×N phase values. However, the overhead of signaling the set of restricted precoding vectors is large. Moreover, this option does not provide a straightforward approach to restrict candidate precoding vectors that are strongly correlated to the restricted precoding vectors.

Note that for 3GPP release 16 (Rel-16) eType-II codebook and 3GPP release 17 (Rel-17) FeType-II port selection (PS) codebook, the reference amplitude value and the differential amplitude value are quantized as follows:
The reference amplitude for weaker polarization takes on values of −1.5 dB step size, i.e.

$$\{ 1 , {( \frac{1}{2} )}^{\frac{1}{4}} , {( \frac{1}{4} )}^{\frac{1}{4}} , … , {( \frac{1}{{2}^{14}} )}^{\frac{1}{4}} \} .$$

The coefficient amplitudes take on values

$$\{ 1 , {( \frac{1}{2} )}^{\frac{1}{2}} , {( \frac{1}{4} )}^{\frac{1}{2}} , … , {( \frac{1}{{2}^{7}} )}^{\frac{1}{4}} \} ,$$

i.e., −3 dB step size.

Within the restricted beam groups, there are two special use cases that are trivial to deal with: the case of unrestricted beams (i.e., beams with unit amplitude) and the case of fully restricted beams (i.e., beams with zero amplitude). This is because in these special use cases the beam would then be fully utilized (or fully abandoned) when designing the precoder. However, it is non-trivial to deal with partially restricted beams (i.e., beams with positive amplitude less than unity). Therefore, for the partial restriction case, CBSR is applied to the average channel gain associated with different FD transformation.

Regarding the 3GPP NR 3GPP release 15 (Rel-15) Type-II codebook, it is assumed that the gNB is equipped with a two-dimensional (2D) antenna array with N1, N2 antenna ports per polarization placed horizontally and vertically and communication occurs over N3 PMI subbands. A PMI subband consists of a set of resource blocks, each resource block consisting of a set of subcarriers. In such case, 2N₁N₂ CSI-RS ports are utilized to enable DL channel estimation with high resolution for NR Rel-15 Type-II codebook. Further details on NR codebook types can be found in 3GPP TS 38.214.

In order to reduce the UL feedback overhead, a DFT-based CSI compression of the SD is applied to L dimensions per polarization, where L<N₁N₂. In the following, the indices of the 2L dimensions are referred to as the SD basis indices. The magnitude and phase values of the linear combination coefficients for each subband are fed back to the gNB as part of the CSI report. The 2N₁N₂×N₃ codebook per transmission layer l takes on the form:

$$W = {W}_{1} {W}_{2 , l}$$

where the matrix W₁ is a 2N₁N₂×2L block-diagonal matrix (where L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix} \\ {l}_{i} = {O}_{1} {n}_{1}^{( i )} + {q}_{1} , 0 \leq {n}_{1}^{( i )} < {N}_{1} , 0 \leq {q}_{1} < {O}_{1} \\ {m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. Note that O₁, O₂ oversampling factors are assumed for the 2D DFT matrix from which matrix B is drawn.

Note that the matrix W₁ is common across all transmission layers. The matrix W_{2·l} is a 2L×N₃ matrix, where the i^{th} column corresponds to the linear combination coefficients of the 2L beams in the i^{th} subband. Only the indices of the L selected columns of B are reported, along with the oversampling index taking on O₁O₂ values. Note that W_{2,l} are independent for different transmission layers.

Regarding 3GPP NR Rel-15, for Type-II PS codebook, only K (where K≤2N₁N₂) beamformed CSI-RS ports are utilized in DL transmission, in order to reduce complexity. The K×N₃ codebook matrix per transmission layer l takes on the form:

$$W = {W}_{1}^{PS} {W}_{2 , l}$$

Here, the matrices W_{2,l} follow the same structure as the conventional NR Rel-15 Type-II codebook, and are transmission layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is a

$$\frac{K}{2} \times L$$

matrix whose columns are standard unit vectors, as follows:

$$E = [ \begin{matrix}{e}_{mo d ( {m}_{PS} {d}_{PS} , K / 2 )}^{( K / 2 )} & {e}_{mo d ( {m}_{PS} {d}_{PS} + 1 , K / 2 )}^{( K / 2 )} & … & {e}_{mo d ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The matrix W₁ is common across all transmission layers.

For K=16, L=4 and d_{PS}=1, the 8 possible realizations of E corresponding to m_{PS}= {0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first ‘1’ in the first column of E, whereas d_{PS} represents the row shift corresponding to different values of m_{PS}.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for Rank Indicator (RI)=1, 2, wherein a phase coupling value is reported for each subband, i.e., W_{2·l} is 2×N₃, with the first row equal to [1, 1, . . . , 1] and the second row equal to [e^{j2πØ}^{₀}, . . . ,

$$[ {e}^{′ 2 π {∅}_{0}} , … , {e}^{j 2 π {∅}_{{N}_{3} - 1}} ] .$$

]. Under specific configurations, φ₀=φ₁ . . . =φ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Rel-16 Type-II codebook, it is assumed that the gNB is equipped with a 2D antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel-16 Type-II codebook. In order to reduce the UL feedback overhead, a DFT-based CSI compression of the SD is applied to L dimensions per polarization, where L<N₁N₂. Similarly, additional compression in the FD is applied, where each beam of the FD precoding vectors is transformed using an inverse DFT matrix to the delay domain, and the magnitude and phase values of a subset of the delay-domain coefficients are selected and fed back to the gNB as part of the CSI report.

The 2N₁N₂×N₃ codebook per transmission layer l takes on the form:

$$W = {W}_{1} {\tilde{W}}_{2 , l} {W}_{f , l}^{H}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ] ,\end{matrix}$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation, and the superscript ^{H} denotes a matrix Hermitian, i.e., conjugate transposition operator. Note that O₁, O₂ oversampling factors are assumed for the 2D DFT matrix from which matrix B is drawn. Note that W₁ is common across all transmission layers. In various embodiments, the above parameters comply with 3GPP TS 38.214 definitions and procedures.

The matrices W_{f,l} are an N₃×M matrices (where M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}} ] , & 0 \leq {k}_{i} \leq {N}_{3} - 1\end{matrix}$$

$${f}_{k} = [ \begin{matrix}1 & {e}^{- j \frac{2 π k}{{N}_{3}}} & … & {e}^{{- j \frac{2 π k ( {N}_{3} - 1 )}{{N}_{3}} ]}^{T}}\end{matrix}$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected FD basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}_{2,l}, W_{f,l} are selected independently for different transmission layers.

Amplitude and phase values of an approximately β fraction of the 2LM available coefficients are reported to the gNB (β<1) as part of the CSI report. Note that coefficients with zero magnitude are indicated via a per-layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of ┌2βLM┐−1 coefficients (along with the indices of selected L, M DFT vectors) are reported per transmission layer, leading to significant reduction in CSI report size, compared with reporting 2N₁N₂×N₃−1 coefficients' information of a theoretical design.

Regarding 3GPP NR Rel-16, for Type-II PS codebook, only K (where K≤2N₁N₂) beamformed CSI-RS ports are utilized in DL transmission, in order to reduce complexity. The K×N₃ codebook matrix per transmission layer l takes on the form:

$$W = {W}_{1}^{PS} {\tilde{W}}_{2 , l} {W}_{f , l}^{H}$$

Here, \tilde{W}_{2,l} and W_{f,l} follow the same structure as the conventional NR Rel-16 Type-II codebook, described above, where both are transmission layer specific. The matrix

$${W}_{1}^{P S}$$

is a K×2L block-diagonal matrix with the same structure as that in the NR Rel-15 Type-II PS codebook, described above.

The 3GPP NR Rel-17 Type-II PS codebook follows a similar structure as that of Rel-15 and Rel-16 Type-II PS codebooks, as follows:

$${W}_{l} = {\overline{W}}_{1}^{PS} {\tilde{W}}_{2 , l} {W}_{f , l}^{H} .$$

where the superscript ^{H} denotes a matrix Hermitian, i.e., conjugate transposition operator.

Here, \tilde{W}_{2,l} and W_{f,l} follow the same structure as the conventional NR Rel-16 Type-II codebook; however M is limited to 1,2 only, with the network configuring a window of size N={2,4} for M=2. Moreover, the bitmap is reported unless β=1 and the UE reports all the coefficients for a rank up to a value of two.

However, unlike Rel-15 and Rel-16 Type-II PS codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers.

Regarding codebook reporting, the CSI codebook report may be partitioned into two parts based on the priority of information reported. Each part is encoded separately. Note that Part 1 of the codebook report may possibly have a higher code rate. Below is listed list the parameters for NR Rel-16 Type-II codebook only. More details can be found in 3GPP TS 38.214, Sections 5.2.3 and 5.2.4.

Regarding the contents of the CSI report, Part 1 of the CSI report comprises a RI, plus a channel quality indicator (CQI), plus the total number of coefficients (i.e., represented using a single value). Part 2 of the CSI report comprises a SD basis indicator, plus a FD basis indicator per layer, plus a bitmap per layer, plus coefficient amplitude information per layer, plus coefficient phase information per layer, plus a strongest coefficient indicator per layer.

Furthermore, Part 2 of the CSI report can be decomposed into sub-parts each with different priority (higher priority information listed first). Such partitioning is required to allow dynamic reporting size for codebook based on available resources in the uplink phase. More details can be found in 3GPP TS 38.214, Section 5.2.3.

Also Type-II codebook is based on aperiodic CSI reporting, and only reported in PUSCH via downlink control information (DCI) triggering (one exception). Type-I codebook can be based on periodic CSI reporting (i.e., using physical uplink control channel (PUCCH)) or semi-persistent (SP) CSI reporting (i.e., using PUSCH or PUCCH) or AP reporting (i.e., using PUSCH).

Regarding the triggering of AP CSI reporting on PUSCH, the UE needs to report the needed CSI information for the network using the CSI framework in NR Rel-15. The triggering mechanism between a report setting and a resource setting can be summarized in Table 1 below:

TABLE 1
Triggering mechanism between a report
setting and a resource setting

| | | Periodic CSI | SP CSI | AP CSI |
|---|---|---|---|---|
| | | Reporting | Reporting | Reporting |
| Time Domain | Periodic | RRC | MAC CE (PUCCH) | DCI |
| Behavior of | CSI-RS | configured | DCI (PUSCH) | |
| Resource | SP | Not | MAC CE (PUCCH) | DCI |
| Setting | CSI-RS | Supported | DCI (PUSCH) | |
| | AP | Not | Not Supported | DCI |
| | CSI-RS | Supported | | |

Moreover, all associated resource settings for a CSI report setting need to have same time domain behavior. Periodic CSI-RS resource and/or CSI-IM resource and CSI reports are always assumed to be present and active once configured by RRC. AP and SP CSI-RS resources and/or CSI-IM resources and CSI reports need to be explicitly triggered or activated. For AP CSI-RS resources and/or CSI-IM resources and AP CSI reports, triggering the associated resources may be done jointly by transmitting a DCI Format 0-1. For SP CSI-RS resources and/or CSI-IM resources and SP CSI reports, the associated resources are independently activated.

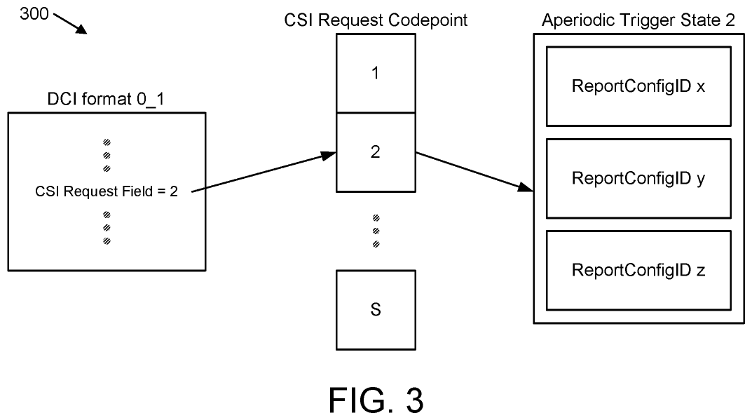

FIG. 3 illustrates an exemplary scenario 300 of an AP trigger state defining a list of CSI reporting settings, in accordance with aspects of the present disclosure. For AP CSI-RS resources and/or CSI-IM resources and AP CSI reports, the triggering is done jointly by transmitting a DCI Format 0_1. The DCI Format 0_1 contains a CSI request field (0 to 6 bits). A non-zero request field points to a so-called AP trigger state configured by RRC. An AP trigger state in turn is defined as a list of up to 16 AP CSI report settings, identified by a CSI report setting identifier (ID) for which the UE calculates simultaneously CSI and transmits it on the scheduled PUSCH transmission.

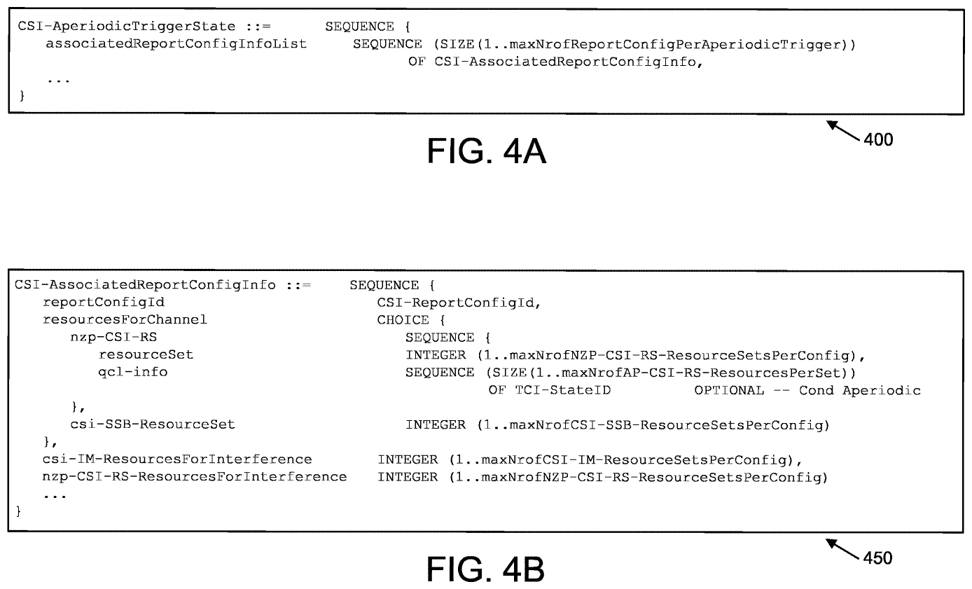

FIG. 4A illustrates an exemplary ASN.1 representation of an AP trigger state parameter 400 that points to associated report configuration information, in accordance with aspects of the present disclosure. The AP trigger state parameter 400 may be implemented using the higher layer parameter CSI-AperiodicTriggerState, e.g., as described in 3GPP TS 38.214 and TS 38.331. FIG. 4B illustrates an exemplary ASN.1 representation of an associated report configuration information parameter 450 that indicates the resource set and QCL information for AP CSI reporting, in accordance with aspects of the present disclosure. The AP trigger state parameter 400 may be implemented using the higher layer parameter CSI-AperiodicTriggerState, e.g., as described in 3GPP TS 38.331. In various embodiments, the AP trigger state parameter 400 (e.g., CSI-AperiodicTriggerState) and associated report configuration information parameter 450 (e.g., CSI-AssociatedReportConfigInfo) are part of the CSI-AperiodicTriggerStateList IE used to configure the UE with a list of aperiodic trigger states.

When the CSI report setting is linked with AP resource setting (can comprise multiple resource sets), the AP NZP CSI-RS Resource Set for channel measurement, the AP CSI-IM Resource Set (if used) and the AP NZP CSI-RS Resource Set for interference management (if used) to use for a given CSI report setting are also included in the AP trigger state definition. For AP NZP CSI-RS, the QCL source to use is also configured in the AP trigger state. The UE assumes that the resources used for the computation of the channel and interference can be processed with the same spatial filter, i.e., quasi-co-located with respect to “QCL-TypeD.”

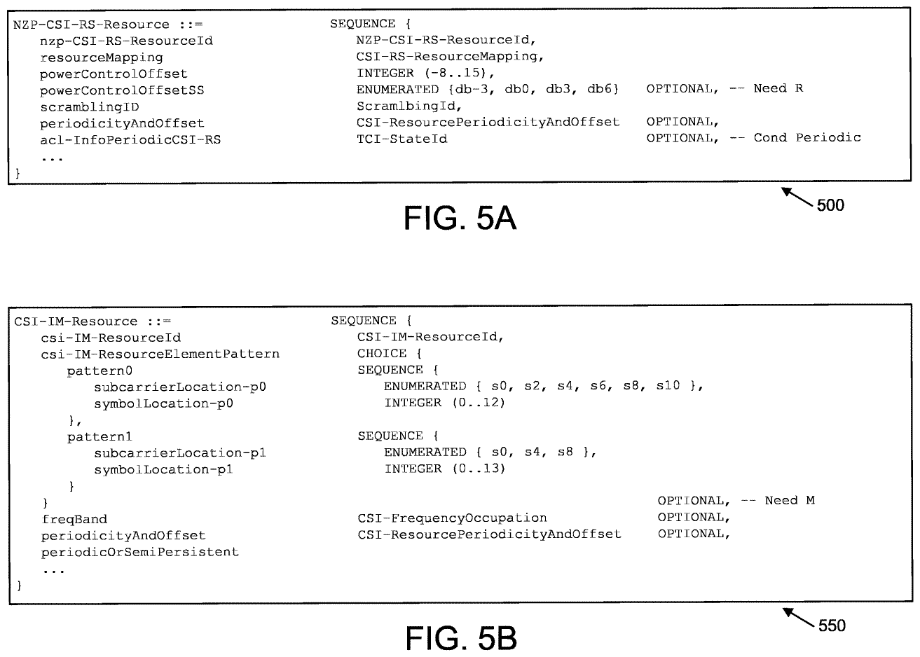

FIG. 5A illustrates an exemplary ASN.1 representation of an RRC configuration 500 for NZP CSI-RS resources, in accordance with aspects of the present disclosure. The RRC configuration 500 for NZP CSI-RS resources may be implemented using the higher layer parameter NZP-CSI-RS-Resource, e.g., as described in 3GPP TS 38.214 and TS 38.331. In various embodiments, the RRC configuration 500 for NZP CSI-RS resources may be part of the NZP CSI-RS-Resource IE used to configure NZP CSI-RS transmitted in the cell where the IE in included, and which the UE may be configured to measure. FIG. 5B illustrates an exemplary ASN.1 representation of an RRC configuration 550 for CSI-IM resources, in accordance with aspects of the present disclosure. The RRC configuration 550 for CSI-IM resources may be implemented using the higher layer parameter CSI-IM-Resource, e.g., as described in 3GPP TS 38.214 and TS 38.331. In various embodiments, the RRC configuration 550 for CSI-IM resources may be part of the CSI-IM-Resource IE used to configure a CSI-IM resource.

For AP CSI reporting, PUSCH-based reports are divided into two CSI parts: CSI Part 1 and CSI Part 2. The reason for this is that the size of CSI payload varies significantly, and therefore a worst-case uplink control information (UCI) payload size design would result in large overhead. CSI Part 1 has a fixed payload size (and can be decoded by the gNB without prior information) and contains the following: 1) RI (if reported), CSI-RS resource indicator (CRI) (if reported) and CQI for the first codeword, and 2) number of non-zero wideband amplitude coefficients per layer for Type-II CSI feedback on PUSCH.

CSI Part 2 has a variable payload size that can be derived from the CSI parameters in CSI Part 1 and contains PMI and the CQI for the second codeword when RI>4.

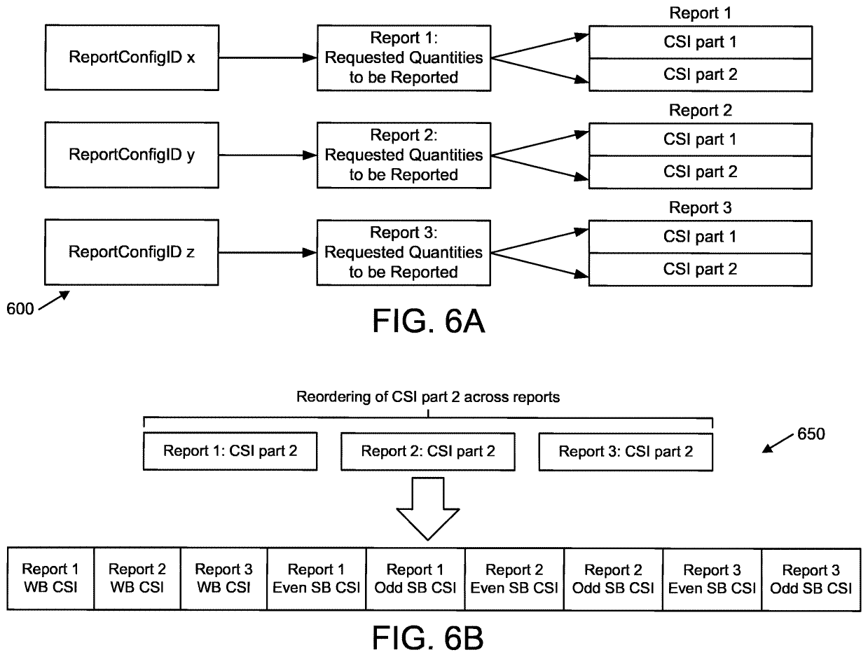

As an example, if the AP trigger state indicated by DCI format 0_1 defines three report settings x, y, and z, then the AP CSI reporting for CSI part 2 will be ordered as depicted in FIGS. 6A and 6B.

FIG. 6A illustrates an exemplary scenario 600 of CSI report generation, in accordance with aspects of the present disclosure. In the depicted example, The DCI format 0_1 depicted report settings for three CSI reporting configurations x, y, and z.

FIG. 6B illustrates an exemplary scenario 650 of partial CSI omission and reordering for PUSCH-based CSI, in accordance with aspects of the present disclosure.

CSI reports are prioritized according to: 1) time-domain behavior and physical channel, where more dynamic reports are given precedence over less dynamic reports and PUSCH has precedence over PUCCH; 2) CSI content, where beam reports (i.e., L1 reference signal received power (L1-RSRP) reporting) has priority over regular CSI reports; 3) the serving cell to which the CSI corresponds (in case of carrier aggregation operation). CSI corresponding to the primary cell (PCell) has priority over CSI corresponding to secondary cells (SCells), and 4) the parameter reportConfigID.

As described above, CBSR has been supported for NR Rel-15 Type-I CSI and Type-II CSI for controlling inter-cell interference levels. In NR Rel-15 Type-I CBSR, a size N₁N₂O₁O₂ bitmap is used to indicate the restricted beam, where N₁/N₂ and O₁/O₂ indicate the number of horizontal/vertical ports and horizontal/vertical oversampling factors, respectively. Each bit in the sequence is used to restrict a certain DFT beam for a given oversampling index.

The bitmap parameter typeI-SinglePanel-codebookSubsetRestriction-i2 forms the bit sequence b₁₅, . . . , b₁, b₀ where b₀ is the least-significant bit and b₁₅ is the most significant bit. The bit bᵢ is associated with precoders corresponding to codebook index i₂=i. When bᵢ is zero, the randomly selected precoder for CQI calculation is not allowed to correspond to any precoder associated with the bit bᵢ.

In NR Rel-15 Type-II CBSR, instead of a hard restriction decision, i.e., a DFT beam within an oversampling index is either fully prohibited or unrestrictedly available, an amplitude restriction is further imposed as follows:
1) The N₁N₂O₁O₂ candidate DFT beams are re-grouped into O₁O₂ beam groups (beams within a beam group do not necessarily belong to the same oversampling index).
2) Beam restriction is only allowed on 4 out of the O₁O₂ beam groups, i.e.,

$$⌈ {log}_{2} {C}_{4}^{{O}_{1} {O}_{2}} ⌉$$

bits are used to indicate the restricted beam groups.
3) For the 4N₁N₂ restricted beams across the 4 beam groups, 2 bits are allocated per beam to indicate the restriction on the maximum allowed amplitude value from a codebook of amplitude value restrictions, wherein the amplitude restriction,

$$Amplitude = \{ 1 , {( \frac{1}{2} )}^{\frac{1}{2}} , {( \frac{1}{2} )}^{\frac{1}{2}} , 0 \} ,$$

i.e., −3 dB step size per restriction value in power domain. Hence, 8N₁N₂ bits are required to report the amplitude restrictions for the 4 restricted beam groups based on Type-II soft restriction.

The bitmap parameter n1-n2-codebookSubsetRestriction-r16 forms the bit sequence B=B₁B₂ and configures the vector group indices g^{(k)}, k=0, . . . , 3, corresponding to the 4 restricted beam groups, e.g., as described in clause 5.2.2.2.3 of 3GPP TS 38.214, v17.4.0. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i+pL} (p=0,1), with i∈{0, 1, . . . , L−1} corresponding to a beam index, of the coefficients associated with the vector in group g^{(k)} indexed by x₁, x₂, where the maximum amplitudes are given in Table 1 and the average coefficient amplitude is restricted as follows

$$\sqrt{\frac{1}{{Σ}_{f = 0}^{{M}_{υ} - 1} {k}_{l , i + pL , f}^{( 3 )}} {\sum }_{f = 0}^{{M}_{υ} - 1} {{k}_{l , i + p L , f}^{( 3 )} ( {p}_{l , p}^{( 1 )} {p}_{l , i + pL , f}^{( 2 )} )}^{2}} \leq {γ}_{i + p L}$$

for l=1, . . . , v, is a layer index, f∈{0, 1, . . . , Mᵥ−1} is a FD basis index, and p=0, 1 is a polarization index. A UE that does not report the parameter softAmpRestriction-r16= ‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01 or 10$$

TABLE 2
Maximum allowed average coefficient amplitudes for restriction vectors

| Bit | |
|---|---|
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Maximum Average Coefficient Amplitude γ_{i+pL} |
| 00 | 0 |
| 01 | \sqrt{1/4} |
| 10 | \sqrt{1/2} |
| 11 | 1 |

For AI/ML-based CSI feedback, the legacy approach to CBSR may not be usable if the underlying design of the precoding matrix is not based on a DFT transformation. Accordingly, the below solutions describe a CBSR-like mechanism that is generic with respect to the underlying design of the precoding matrix.

In the below descriptions, the following notions are used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a transmission configuration indicator (TCI) state from a transmission configuration comprising at least two TCI states.

In the following solutions, it is assumed that codebook type used for PMI reporting is flexible (e.g., arbitrary) to permit use of different codebook types, e.g., Type-II Rel-16 codebook, Type-II Rel-17 codebook, Type-II 3GPP release 18 (Rel-18) codebook, etc. Several solution sets are described below. According to a possible implementation, one or more elements or features from one or more of the described solution sets may be combined.

As used herein, a tracking reference signal (TRS) corresponds to an NZP CSI-RS resource set with a parameter ‘trs-info’ being configured; a CSI-RS for beam management corresponds to an NZP CSI-RS resource set with a parameter ‘repetition’ being configured; a CSI-RS for CSI corresponds to an NZP CSI-RS resource set with neither parameters ‘trs-info’ nor ‘repetition’ being configured.

As used herein, a matrix implies a sequence of fields of an arbitrary dimension, including an array (vector) of values, a standard 2D matrix and more generally a Q-dimensional matrix (tensor), wherein Q≥2 and Q is an integer value. In the below descriptions, a mapping between a transport block and a codeword transmitted in DL can be based on a one-to-one mapping between the TBs and codewords, unless indicated otherwise.

Further, the term CBSR may be used interchangeably with any of the following terms: beam restriction, precoder restriction, precoding vector restriction, precoding matrix restriction, PMI restriction, CSI restriction, interference restriction, inter-cell interference restriction, leakage restriction, beam restriction, correlation restriction, similarity restriction, or some combination thereof.

According to the solutions described herein, the network (e.g., the RAN node 208) would configure a UE 206 with a CSI feedback based on a CSI reporting setting, the CSI reporting setting comprising a codebook configuration including a CBSR. An indication of such CBSR can be a combination of one or more of the following:

In a first implementation, the indication of a CBSR may be configured via a higher-layer parameter (e.g., an RRC parameter) corresponding to a CSI reporting setting, e.g., CSI-ReportConfig. In such embodiments, the CSI reporting setting may comprise a report quantity, e.g., reportQuantity, comprising at least one PMI value, e.g., PMI. In this embodiment, a PMI restriction or inter-cell interference restriction parameter is further configured as part of the CSI reporting setting, e.g., PMI-Restriction.

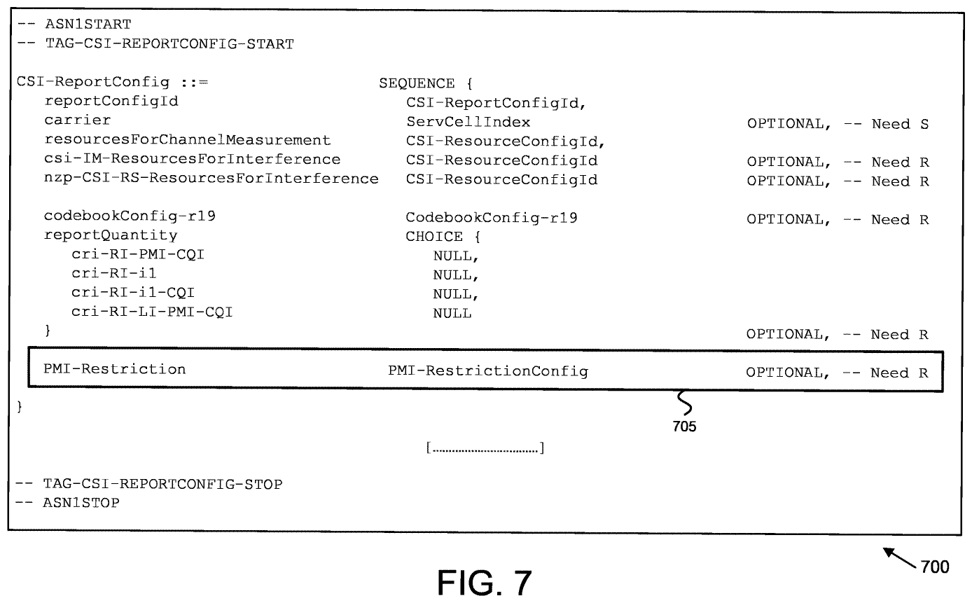

FIG. 7 illustrates an exemplary ASN.1 representation of the CSI reporting setting IE 700, in accordance with aspects of the present disclosure. The depicted CSI reporting setting IE 700 is based on the IE CSI-ReportConfig found in Clause 6.3.2 of 3GPP TS 38.331 v17.3.0. The CSI reporting setting IE 700 contains a parameter PMI-Restriction 705 that configures the CBSR.

In a second implementation, the indication of a CBSR may be configures via a higher-layer parameter (e.g., an RRC parameter) corresponding to a codebook subset restriction setting, e.g., n1-n2-codebookSubsetRestriction-r19, within the codebook configuration CodebookConfig 1E, e.g., CodebookConfig-r19.

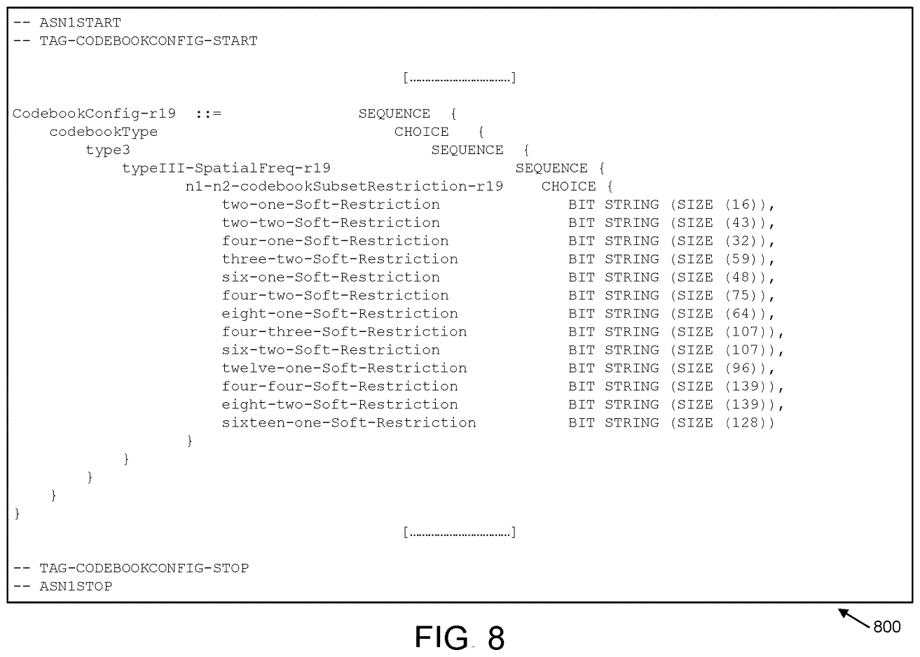

FIG. 8 illustrates an exemplary ASN.1 representation of a codebook configuration IE 800, in accordance with aspects of the present disclosure. The depicted codebook configuration IE 800 is based on the IE CodebookConfig found in Clause 6.3.2 of 3GPP TS 38.331 v17.3.0. The codebook configuration IE 800 corresponds to a CBSR with soft amplitude restriction, referred to herein as “soft CBSR”, wherein a set of possible threshold values corresponding to a normalized amplitude restriction takes on at least one non-zero value in addition to the two values {0,1}, e.g.,

$$\{ \frac{1}{2} , \frac{1}{\sqrt{2}} \} ,$$

wherein values {0,1} correspond to full restriction and no restriction on the amplitude, respectively, and

$$\{ \frac{1}{2} , \frac{1}{\sqrt{2}} \}$$

correspond to partial restriction with an attenuated amplitude value.

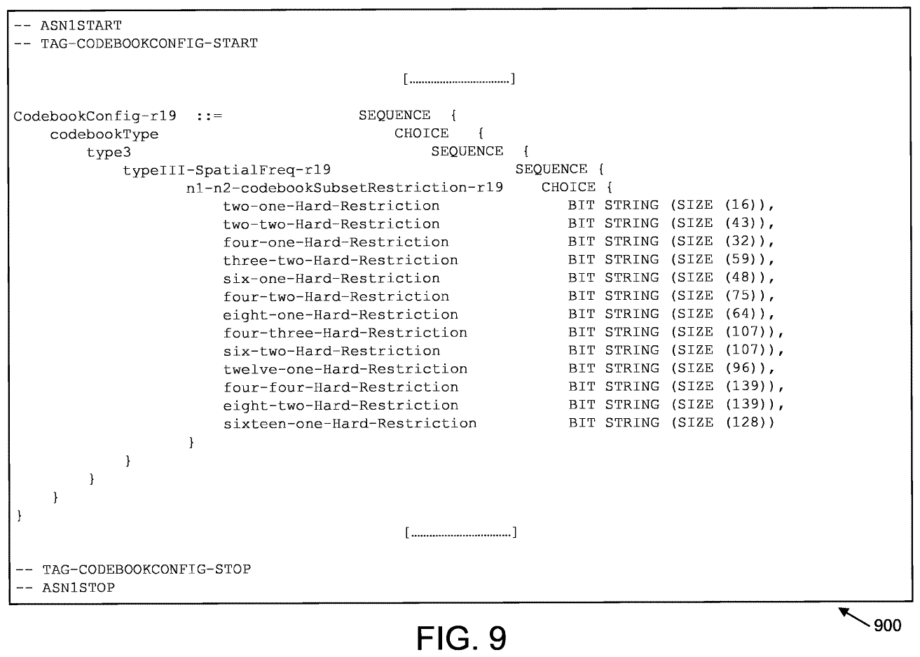

FIG. 9 illustrates an exemplary ASN.1 representation of the codebook configuration IE 900, in accordance with aspects of the present disclosure. The depicted codebook configuration IE 900 is based on the IE CodebookConfig found in Clause 6.3.2 of 3GPP TS 38.331 v17.3.0. The codebook configuration IE 900 corresponds to a CBSR with hard amplitude restriction, referred to herein as “hard CBSR”, wherein a set of possible threshold values corresponding to a normalized amplitude restriction takes on two values {0,1} corresponding to full restriction and no restriction on the amplitude, respectively.

In order to achieve the targeted restriction on the PMI, e.g., CBSR, a pre-configured set of restriction vectors may be defined, such that the network may restrict a subset of the set of restriction vectors. According to a possible implementation, a combination of one or more of the below embodiments is not precluded.

In a first embodiment, the pre-configured set of restriction vectors comprises a set of columns of a standard transformation matrix. In a first implementation of this embodiment, the standard transformation matrix corresponds to a Fourier-based matrix, e.g., DFT matrix with one or more phase offset values corresponding to oversampling factors of the DFT matrix.

In a second implementation of this embodiment, the standard transformation matrix corresponds to a sinusoidal-transform-based matrix, e.g., discrete cosine transform (DCT) matrix or discrete sine transform (DST), with one or more phase offset values corresponding to oversampling factors of the DFT matrix. In a third implementation of this embodiment, the standard transformation matrix corresponds to a wavelet-transform-based matrix, e.g., discrete wavelet transform (DWT) matrix.

In a second embodiment, the subset of the set of restriction vectors comprises N′ vectors selected from the set of N restriction vectors, and N′≤N. The following examples are provided, wherein a matrix C corresponds to the subset of the set of restriction vectors comprising N′ vectors:

As a first example, consider the one-dimensional DFT matrix transformation:

$${f}_{k} = {[ \begin{matrix}1 & {e}^{j \frac{2 π k}{ON}} & … & {e}^{j \frac{2 π k ( N - 1 )}{N}}\end{matrix} ]}^{T} , 0 \leq k \leq N - 1 \\ C = [ \begin{matrix}{f}_{{k}_{0}} & {f}_{{k}_{1}} & … & {f}_{{k}_{{N}^{′} - 1}} ]\end{matrix} , 0 \leq {k}_{i} \leq N - 1$$

As a second example, consider the oversampled one-dimensional DFT matrix transformation:

$${f}_{k} = [ \begin{matrix}1 & {e}^{j \frac{2 π k}{ON}} & … & {{e}^{j \frac{2 π k ( N - 1 )}{ON}} ]}^{T} ,\end{matrix} 0 \leq k \leq ON - 1 , \\ C = [ \begin{matrix}{f}_{{k}_{0}} & {f}_{{k}_{1}} & … & {f}_{{k}_{{N}^{′} - 1}}\end{matrix} ] , 0 \leq {k}_{i} \leq N - 1 , \\ {k}_{i} = {On}^{( i )} + q , 0 \leq {n}^{( i )} < N , 0 \leq q < O ,$$

As a third example, consider the one-dimensional DCT matrix transformation:

$${f}_{k} = \sqrt{\frac{1 + ⌈ \frac{k}{N} ⌉}{N}} \cdot {[ \begin{matrix}cos \frac{k π}{2 N} & cos \frac{3 k π}{2 N} & … & cos \frac{( 2 N - 1 ) k π}{2 N}\end{matrix} ]}^{T} , 0 \leq k \leq N - 1 \\ C = [ \begin{matrix}{f}_{{k}_{0}} & {f}_{{k}_{1}} & … & {f}_{{k}_{{N}^{′} - 1}}\end{matrix} ] , 0 \leq {k}_{i} \leq N - 1$$

As a further example, consider the one-dimensional DST matrix transformation:

$${f}_{k} = \sqrt{\frac{1 + ⌈ \frac{k}{{N}_{3}} ⌉}{N}} \cdot {[ \begin{matrix}sin \frac{k π}{2 N} & sin \frac{3 k π}{2 N} & … & sin \frac{( 2 N - 1 ) k π}{2 N}\end{matrix} ]}^{T} , 0 \leq k \leq N - 1 \\ C = [ \begin{matrix}{f}_{{k}_{0}} & {f}_{{k}_{1}} & … & {f}_{{k}_{{N}^{′} - 1}}\end{matrix} ] , 0 \leq {k}_{i} \leq N - 1$$

In a third embodiment, the set of restriction vectors may be based on a standard transformation matrix that transforms two dimensions, e.g., joint time/Doppler domain and frequency domain, the following examples are provided:

As a first example, consider the two-dimensional DFT matrix transformation:

$${f}_{k} = [ \begin{matrix}1 & {e}^{j \frac{2 π k}{{N}_{1}}} & … & {{e}^{j \frac{2 π k ( {N}_{1} - 1 )}{{N}_{1}}} ]}^{T} ,\end{matrix} 0 \leq k \leq {N}_{1} - 1 \\ {z}_{δ , k} = {[ \begin{matrix}{f}_{k}^{T} & {e}^{j \frac{2 π δ}{{N}_{2}}} {f}_{k}^{T} & … & {e}^{j \frac{2 π δ}{{N}_{2}}} {f}_{k}^{T} & … & {e}^{j \frac{2 π ( {N}_{2} - 1 )}{{N}_{2}}} {f}_{k}^{T}\end{matrix} ]}^{T} , 0 \leq δ \leq {N}_{2} - 1 \\ C = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}}\end{matrix} ] , 0 \leq {k}_{i} \leq {N}_{1} - 1 , 0 \leq {δ}_{i} \leq {N}_{2} - 1$$

As a second example, consider the oversampled two-dimensional DFT matrix transformation:

$${f}_{k} = [ \begin{matrix}1 & {e}^{j \frac{2 π k}{{O}_{1} {N}_{1}}} & … & {e}^{j \frac{2 π k ( {N}_{1} - 1 )}{{O}_{1} {N}_{1}}} ] ,\end{matrix} 0 \leq k \leq {O}_{1} {N}_{1} - 1 \\ {z}_{δ , k} = [ \begin{matrix}{f}_{k}^{T} & {e}^{j \frac{2 πδ}{{O}_{2} {N}_{2}}} {f}_{k}^{T} & … & {e}^{j \frac{2 π δ}{{O}_{2} {N}_{2}}} {f}_{k}^{T} & … & {{e}^{j \frac{2 π δ ( {N}_{2} - 1 )}{{O}_{2} {N}_{2}}} {f}_{k}^{T} ]}^{T}\end{matrix} , \\ 0 \leq δ \leq {O}_{2} {N}_{2} - 1 C = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {O}_{1} {N}_{1} - 1 , \\ 0 \leq {δ}_{i} \leq {O}_{2} {N}_{2} - 1 \\ {k}_{i} = {O}_{1} {n}_{1}^{( i )} + {q}_{1} , 0 \leq {n}_{1}^{( i )} < {N}_{1} , 0 \leq {q}_{1} < {O}_{1} , \\ {δ}_{i} = {O}_{2} {n}_{2}^{( i )} + {q}_{2} , 0 \leq {n}_{2}^{( i )} < {N}_{2} , 0 \leq {q}_{2} < {O}_{2} .$$

As a third example, consider the two-dimensional DCT matrix transformation:

$${f}_{k} = \sqrt{\frac{1 + ⌈ \frac{k}{{N}_{3}} ⌉}{{N}_{3}}} \cdot {[ \begin{matrix}cos \frac{k π}{2 {N}_{3}} & cos \frac{3 k π}{2 {N}_{3}} & … & cos \frac{( 2 {N}_{3} - 1 ) k π}{2 {N}_{3}}\end{matrix} ]}^{T} , \\ 0 \leq k \leq {N}_{3} - 1 \\ {z}_{δ , k} = \sqrt{\frac{1 + ⌈ \frac{δ}{{N}_{4}} ⌉}{{N}_{4}}} \cdot {[ \begin{matrix}cos \frac{δ π}{2 {N}_{4}} \cdot {f}_{k}^{T} & cos \frac{3 δ π}{2 {N}_{4}} \cdot {f}_{k}^{T} & … & cos \frac{( 2 {N}_{4} - 1 ) δ π}{2 {N}_{4}} \cdot {f}_{k}^{T}\end{matrix} ]}^{T} , \\ 0 \leq δ \leq {N}_{4} - 1 \\ C = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}} ]\end{matrix} , 0 \leq {k}_{i} \leq {N}_{3} - 1 , 0 \leq {δ}_{i} \leq {N}_{4} - 1$$

As a fourth example, consider the two-dimensional DST matrix transformation:

$${f}_{k} = \sqrt{\frac{1 + ⌈ \frac{k}{{N}_{3}} ⌉}{{N}_{3}}} \cdot {[ \begin{matrix}sin \frac{k π}{2 {N}_{3}} & sin \frac{3 k π}{2 {N}_{3}} & … & sin \frac{( 2 {N}_{3} - 1 ) k π}{2 {N}_{3}}\end{matrix} ]}^{T} , \\ 0 \leq k \leq {N}_{3} - 1 \\ {z}_{δ , k} = \sqrt{\frac{1 + ⌈ \frac{δ}{{N}_{4}} ⌉}{{N}_{4}}} \cdot {[ \begin{matrix}sin \frac{δ π}{2 {N}_{4}} \cdot {f}_{k}^{T} & sin \frac{3 δ π}{2 {N}_{4}} \cdot {f}_{k}^{T} & … & sin \frac{( 2 {N}_{4} - 1 ) δ π}{2 {N}_{4}} \cdot {f}_{k}^{T}\end{matrix} ]}^{T} , \\ 0 \leq δ \leq {N}_{4} - 1 \\ C = [ \begin{matrix}{z}_{{δ}_{0} , {k}_{0}} & {z}_{{δ}_{1} , {k}_{1}} & … & {z}_{{δ}_{{N}^{′} - 1} , {k}_{{N}^{′} - 1}}\end{matrix} ] , 0 \leq {k}_{i} \leq {N}_{3} - 1 , 0 \leq {δ}_{i} \leq {N}_{4} - 1$$

According to a fourth embodiment, the pre-configured set of restriction vectors may be selected from a set of precoding vectors received from the UE as part of a prior CSI report. In a first implementation of this embodiment, an indicator comprising an identification of a selection of the set of precoding vectors from a prior CSI report is signaled as part of the CBSR.

According to a fifth embodiment, the pre-configured set of restriction vectors may be selected from a plurality of sets of restriction vectors. In a first implementation of this embodiment, an indicator comprising an identification of a selection of the set of restriction vectors from the plurality of sets of restriction vectors is signaled as part of the CBSR. In a second implementation of this embodiment, a selection of the set of restriction vectors from the plurality of sets of restriction vectors is inferred from one of a capability, and a feature associated with the UE.

In order to achieve the targeted restriction on the PMI, e.g., CBSR, a pre-configured CBSR metric may be defined—or indicated—that identifies a correlation value between a candidate precoding vector and the set of restricted CBSR vectors. In various embodiments, a candidate precoding vector is selected as a precoding vector associated with the PMI value if an output of the CBSR metric corresponding to the correlation value between the selected candidate precoding vector with the set of restriction vectors is less than or equal to a CBSR threshold. According to a possible implementation, a combination of one or more of the below embodiments is not precluded.

In a first embodiment, the CBSR metric may be based on an average correlation corresponding to a set of frequency sub-bands. In a first implementation of this embodiment, the CBSR metric computes a wideband value corresponding to an averaged correlation value over the set of frequency sub-bands. Here, the CBSR threshold is applied to the wideband value. Here, a wideband value corresponds to an average value over multiple frequency sub-bands, e.g., within a same bandwidth part.

According to a second embodiment, the CBSR metric may be based on a distinct correlation corresponding for each frequency sub-band of a set of frequency sub-bands. In a first implementation of this embodiment, the CBSR metric computes a distinct correlation value for each frequency sub-band of the set of frequency sub-bands. Here, the CBSR threshold is applied to each correlation value of the set of correlation values associated with the set of frequency sub-bands.

According to a third embodiment, the CBSR metric may be based on a cosine-based similarity function. In a first implementation of this embodiment, an averaged CBSR metric corresponding to a candidate precoding vector v associated with a sub-band j and a k^{th} restriction vector u^{(k)} is as follows:

$$G C {S}_{1} = \frac{\frac{1}{B} {\sum }_{j = 1}^{B} {λ}_{j} \cdot \vert {v}_{j}^{H} {u}^{( k )} \vert}{‖ {u}^{( k )} ‖ \cdot \sqrt{\frac{1}{B} {\sum }_{j = 1}^{B} {‖ {v}_{j} ‖}^{2}}} ,$$

where a^{H} is a matrix Hermitian, i.e., conjugate transposition operator, where |·| is an absolute value operator, where ∥·∥ is a vector norm operator, where B is a number of frequency sub-bands and where λⱼ is a normalization constant for the jth frequency sub-band.

In a second implementation of the third embodiment, a per sub-band CBSR metric corresponding to a candidate precoding vector v associated with a sub-band j and a k^{th} restriction vector u^{(k)} is as follows:

$$G C {S}_{2 , j} = \frac{{λ}_{j} \cdot \vert {v}_{j}^{H} {u}^{( k )} \vert}{‖ {u}^{( k )} ‖ \cdot ‖ {v}_{j} ‖} .$$

According to a fourth embodiment, the CBSR metric is a based on a magnitude of a normalized standard auto-correlation function. In a first implementation of this embodiment, an averaged CBSR metric corresponding to a candidate precoding vector v associated with a sub-band j and a k^{th} restriction vector u^{(k)} is as follows:

$${A}_{1} = \sqrt{\frac{\frac{1}{B} {\sum }_{j = 1}^{B} \vert {v}_{j}^{H} {u}^{( k )} \vert}{‖ {u}^{( k )} ‖ \cdot \sqrt{\frac{1}{B} {\sum }_{j = 1}^{B} {‖ {v}_{j} ‖}^{2}}}} .$$

In a second implementation of the fourth embodiment, a per sub-band CBSR metric corresponding to a candidate precoding vector v associated with a sub-band j and a k^{th} restriction vector u^{(k)} is as follows:

$${A}_{2 , j} = \sqrt{\frac{\vert {v}_{j}^{H} {u}^{( k )} \vert}{‖ {u}^{( k )} ‖ \cdot ‖ {v}_{1} ‖}} .$$

In a third implementation of the fourth embodiment, an averaged CBSR metric corresponding to a candidate precoding vector v associated with a sub-band j and a k^{th} restriction vector u^{(k)} is as follows:

$${A}_{3} = \sqrt{\frac{\frac{1}{B} {\sum }_{j = 1}^{B} \vert {v}_{j}^{H} {u}^{( k )} \vert}{{‖ {u}^{( k )} ‖}^{2} + \frac{1}{B} {\sum }_{j = 1}^{B} {‖ {v}_{j} ‖}^{2}}} .$$

In a fourth implementation of the fourth embodiment, a per sub-band CBSR metric corresponding to a candidate precoding vector v associated with a sub-band j and a k^{th} restriction vector u^{(k)} is as follows:

$${A}_{4 , j} = \sqrt{\frac{\vert {v}_{j}^{H} {u}^{( k )} \vert}{{‖ {u}^{( k} ‖}^{2} + {‖ {v}_{j} ‖}^{2}}} .$$

According to a fifth embodiment, a set of CBSR metrics are defined, wherein the network activates or configures one CBSR metric from the set of CBSR metrics.

In order to achieve the targeted restriction on the PMI, e.g., CBSR, a pre-configured codebook of CBSR threshold values may be defined. Accordingly, the network may configure each restriction vector from the above described subset of the set of restriction vectors with a value from the codebook of CBSR threshold values. According to a possible implementation, a combination of one or more of the below embodiments is not precluded.

In a first implementation, the pre-configured codebook of CBSR threshold values comprises two values, e.g., {0,1}. In this embodiment, the CBSR corresponds to a hard restriction. In a first implementation of the first embodiment, the CBSR threshold value is configured with a CBSR type corresponding to a hard CBSR threshold, or alternatively corresponding to a hard amplitude restriction.

In a second implementation of the first embodiment, the CBSR threshold value is configured without reporting a parameter corresponding to a soft amplitude restriction being supported, e.g., parameter softAmpRestriction≠‘supported’.

In a second implementation, the pre-configured codebook of CBSR threshold values comprises a plurality of values. In this embodiment, the CBSR corresponds to a soft restriction. In a first implementation of the second embodiment, the CBSR threshold value is configured with a CBSR type corresponding to a soft CBSR threshold, or alternatively corresponding to a soft amplitude restriction.

In a second implementation of the second embodiment, the CBSR threshold value is configured with reporting a parameter corresponding to a soft amplitude restriction being supported, e.g., parameter softAmpRestriction=‘supported’. In a third implementation of the second embodiment, the codebook of CBSR threshold values comprises at least one or more values of the set {0, \sqrt{¼}, \sqrt{½},1}.

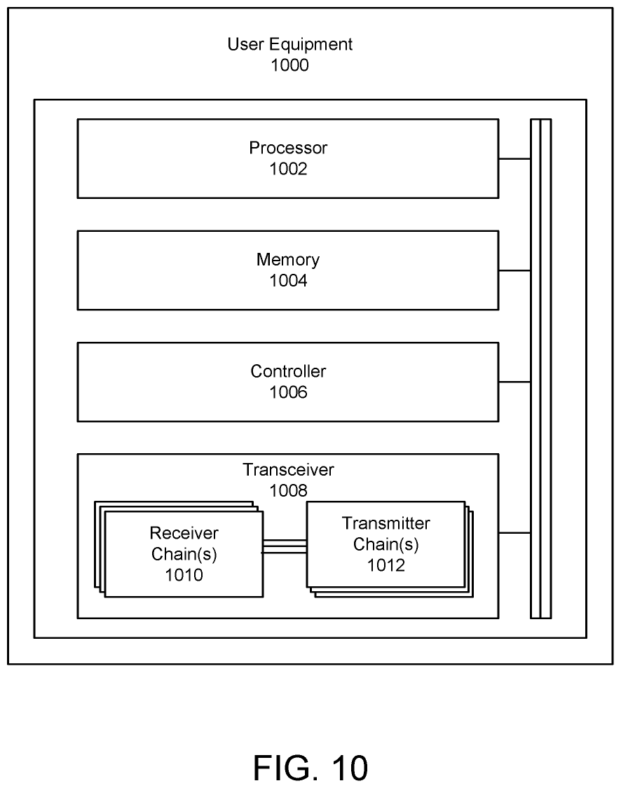

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field programable gate array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the UE functions described herein (e.g., executing, by the processor 1002, instructions stored in the memory 1004). For example, the processor 1002 may support wireless communication at the UE 1000 in accordance with examples as disclosed herein.

The UE 1000 may be configured to or operable to support a means for receiving (e.g., from a network entity, such as a base station (BS) or other RAN node) a CSI reporting setting including an indication of a CBSR (e.g., a precoder restriction) associated with a precoding matrix and a means for receiving a NZP CSI-RS based on the CSI reporting setting, where the CSI reporting setting includes.

The UE 1000 may be configured to or operable to support a means for generating a CSI report including a PMI value and a means for transmitting (e.g., to the network entity) the CSI report including the PMI value, where the PMI value is based on the NZP CSI-RS and the CBSR.

In some implementations, the CBSR includes at least one of: A) a set of restriction vectors (e.g., configured by the network entity), or B) a CBSR metric that identifies a correlation value between a candidate precoding vector and the set of restriction vectors, or C) a CBSR threshold corresponding to the CBSR metric, or D) a combination thereof.

In some implementations, the PMI value is associated with a set of precoding vectors. In such implementations, the UE 1000 may be configured to: A) determine, using the CBSR metric, the correlation value between the candidate precoding vector and the set of restriction vectors; and B) select the candidate precoding vector as an associated precoding vector of the set of associated precoding vectors based on the correlation value satisfying the CBSR threshold.

In some implementations, the set of restriction vectors includes a subset of precoding vectors corresponding to one or more DFT-based matrices. In certain implementations, the one or more DFT-based matrices include a set of oversampled DFT matrices including one or more phase offsets corresponding to oversampling factors.

In some implementations, the set of restriction vectors includes a subset of a pre-configured set of restriction vectors. In certain implementations, the UE 1000 may be configured to receive (e.g., from the network entity) an indication corresponding to the subset of the pre-configured set of restriction vectors.

In certain implementations, the correlation value satisfies the CBSR threshold based on the correlation value being less than or equal to the CBSR threshold. In certain implementations, the UE 1000 may be configured to (e.g., separately) apply the CBSR metric on each frequency band of one or more frequency bands associated with the precoding matrix.

In some implementations, the CBSR metric includes a cosine-based similarity function. In some implementations, the CBSR metric is based on a magnitude of a normalized standard auto-correlation function. In some implementations, the CBSR metric is based on a square of a magnitude of a normalized standard auto-correlation function.

In some implementations, the CBSR metric is based on a wideband value corresponding to an averaged value across one or more frequency bands associated with the precoding matrix. In some implementations, the CBSR metric is based on a per-band value corresponding to a separate value for each frequency band of the one or more frequency bands associated with the precoding matrix.

In some implementations, the CBSR threshold comprises a null value, wherein the null value corresponds to a hard CBSR. In some implementations, a value of the CBSR threshold is configured from a codebook of values of the CBSR threshold, the codebook of values comprising at least one non-zero value, where the non-zero value corresponds to a soft CBSR.

The controller 1006 may manage input and output signals for the UE 1000. The controller 1006 may also manage peripherals not integrated into the UE 1000. In some implementations, the controller 1006 may utilize an operating system (OS) such as iOS®, ANDROID®, WINDOWS®, or other operating systems (OSes). In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receiving signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

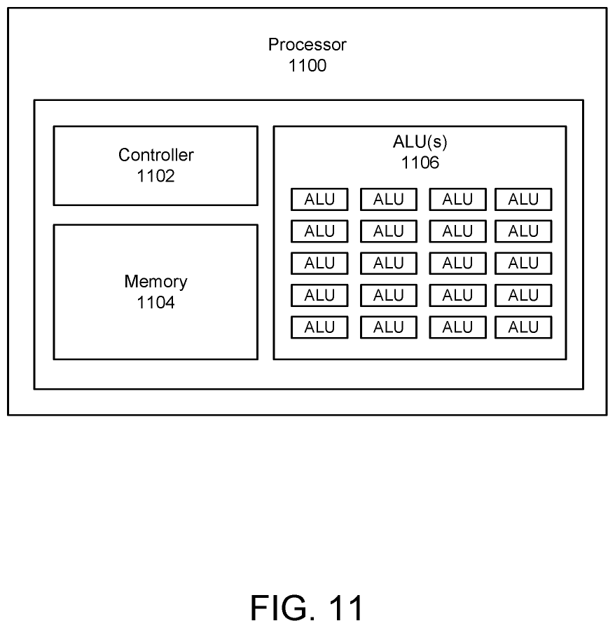

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. For example, the processor 1100 may perform one or more of the UE functions described herein. The processor 1100 may be configured to or operable to support a means for receiving (e.g., from a network entity, such as a BS or other RAN node) a CSI reporting setting including an indication of a CBSR (e.g., a precoder restriction) associated with a precoding matrix and a means for receiving a NZP CSI-RS based on the CSI reporting setting, where the CSI reporting setting includes.

The processor 1100 may be configured to or operable to support a means for generating a CSI report including a PMI value and a means for transmitting (e.g., to the network entity) the CSI report including the PMI value, where the PMI value is based on the NZP CSI-RS and the CBSR.

In some implementations, the CBSR includes at least one of: A) a set of restriction vectors (e.g., configured by the network entity), or B) a CBSR metric that identifies a correlation value between a candidate precoding vector and the set of restriction vectors, or C) a CBSR threshold corresponding to the CBSR metric, or D) a combination thereof.

In some implementations, the PMI value is associated with a set of precoding vectors. In such implementations, the processor 1100 may be configured to: A) determine, using the CBSR metric, the correlation value between the candidate precoding vector and the set of restriction vectors; and B) select the candidate precoding vector as an associated precoding vector of the set of associated precoding vectors based on the correlation value satisfying the CBSR threshold.

In some implementations, the set of restriction vectors includes a subset of precoding vectors corresponding to one or more DFT-based matrices. In certain implementations, the one or more DFT-based matrices include a set of oversampled DFT matrices including one or more phase offsets corresponding to oversampling factors.

In some implementations, the set of restriction vectors includes a subset of a pre-configured set of restriction vectors. In certain implementations, the processor 1100 may be configured to receive (e.g., from the network entity) an indication corresponding to the subset of the pre-configured set of restriction vectors.

In certain implementations, the correlation value satisfies the CBSR threshold based on the correlation value being less than or equal to the CBSR threshold. In certain implementations, the processor 1100 may be configured to (e.g., separately) apply the CBSR metric on each frequency band of one or more frequency bands associated with the precoding matrix.

In some implementations, the CBSR metric includes a cosine-based similarity function. In some implementations, the CBSR metric is based on a magnitude of a normalized standard auto-correlation function. In some implementations, the CBSR metric is based on a square of a magnitude of a normalized standard auto-correlation function.

In some implementations, the CBSR metric is based on a wideband value corresponding to an averaged value across one or more frequency bands associated with the precoding matrix. In some implementations, the CBSR metric is based on a per-band value corresponding to a separate value for each frequency band of the one or more frequency bands associated with the precoding matrix.

In some implementations, the CBSR threshold comprises a null value, wherein the null value corresponds to a hard CBSR. In some implementations, a value of the CBSR threshold is configured from a codebook of values of the CBSR threshold, the codebook of values comprising at least one non-zero value, where the non-zero value corresponds to a soft CBSR.

The processor 1100 may support wireless communication, in accordance with examples as disclosed herein, to perform one or more of the NE functions described herein. For example, the processor 1100 may be configured to or operable to support a means for transmitting (e.g., to a UE) a CSI reporting setting that includes an indication of a CBSR (e.g., a precoder restriction) associated with a precoding matrix.

The processor 1100 may be configured to or operable to support a means for transmitting a NZP CSI-RS based on the CSI reporting setting and a means for receiving (e.g., from the UE) a CSI report including a PMI value based on the NZP CSI-RS and the CBSR.

In some embodiments, the CBSR includes at least one of: A) a set of restriction vectors configured by the network entity, B) a CBSR metric that identifies a correlation value between a candidate precoding vector and the set of restriction vectors, C) a CBSR threshold corresponding to the CBSR metric, or D) a combination thereof.

In some embodiments, the correlation value satisfies the CBSR threshold based on the correlation value being less than or equal to the CBSR threshold. In some embodiments, the processor 1100 may be configured to (e.g., separately) apply the CBSR metric on each frequency band of one or more frequency bands associated with the precoding matrix.

In some embodiments, the set of restriction vectors includes a subset of precoding vectors corresponding to one or more DFT-based matrices. In certain embodiments, the one or more DFT-based matrices include a set of oversampled DFT matrices including one or more phase offsets corresponding to oversampling factors.

In some embodiments, the set of restriction vectors includes a subset of a pre-configured set of restriction vectors. In certain embodiments, the processor 1100 may be configured to transmit (e.g., to the UE) an indication corresponding to the subset of the pre-configured set of restriction vectors.

In some embodiments, the CBSR metric includes a cosine-based similarity function. In some embodiments, the CBSR metric is based on a magnitude of a normalized standard auto-correlation function. In some embodiments, the CBSR metric is based on a square of a magnitude of a normalized standard auto-correlation function.

In some embodiments, the CBSR metric is based on a wideband value corresponding to an averaged value across one or more frequency bands associated with the precoding matrix. In some embodiments, the CBSR metric is based on a per-band value corresponding to a separate value for each frequency band of the one or more frequency bands associated with the precoding matrix.

In some embodiments, the CBSR threshold comprises a null value, where the null value corresponds to a hard CBSR. In some embodiments, a value of the CBSR threshold is configured from a codebook of values of the CBSR threshold, the codebook of values comprising at least one non-zero value, where the non-zero value corresponds to a soft CBSR.

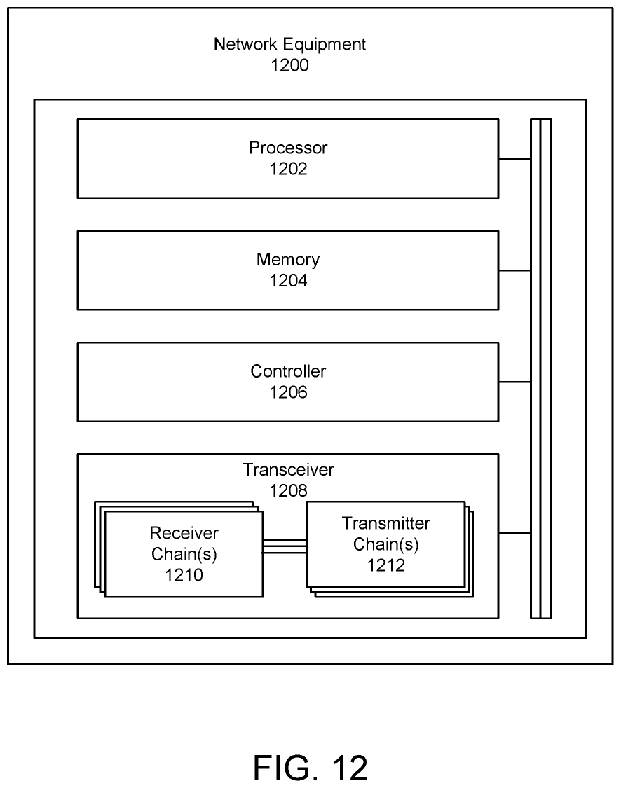

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

In some implementations, the processor 1202 and the memory 1204 coupled with the processor 1202 may be configured to cause the NE 1200 to perform one or more of the NE functions described herein (e.g., executing, by the processor 1202, instructions stored in the memory 1204). For example, the processor 1202 may support wireless communication at the NE 1200 in accordance with examples as disclosed herein.

The NE 1200 may be configured to or operable to support a means for transmitting (e.g., to a UE) a CSI reporting setting that includes an indication of a CBSR (e.g., a precoder restriction) associated with a precoding matrix.

The NE 1200 may be configured to or operable to support a means for transmitting a NZP CSI-RS based on the CSI reporting setting and a means for receiving (e.g., from the UE) a CSI report including a PMI value based on the NZP CSI-RS and the CBSR.

In some embodiments, the CBSR includes at least one of: A) a set of restriction vectors configured by the network entity, B) a CBSR metric that identifies a correlation value between a candidate precoding vector and the set of restriction vectors, C) a CBSR threshold corresponding to the CBSR metric, or D) a combination thereof.

In some embodiments, the correlation value satisfies the CBSR threshold based on the correlation value being less than or equal to the CBSR threshold. In some embodiments, the NE 1200 may be configured to (e.g., separately) apply the CBSR metric on each frequency band of one or more frequency bands associated with the precoding matrix.

In some embodiments, the set of restriction vectors includes a subset of precoding vectors corresponding to one or more DFT-based matrices. In certain embodiments, the one or more DFT-based matrices include a set of oversampled DFT matrices including one or more phase offsets corresponding to oversampling factors.

In some embodiments, the set of restriction vectors includes a subset of a pre-configured set of restriction vectors. In certain embodiments, the NE 1200 may be configured to transmit (e.g., to the UE) an indication corresponding to the subset of the pre-configured set of restriction vectors.

In some embodiments, the CBSR metric includes a cosine-based similarity function. In some embodiments, the CBSR metric is based on a magnitude of a normalized standard auto-correlation function. In some embodiments, the CBSR metric is based on a square of a magnitude of a normalized standard auto-correlation function.

In some embodiments, the CBSR metric is based on a wideband value corresponding to an averaged value across one or more frequency bands associated with the precoding matrix. In some embodiments, the CBSR metric is based on a per-band value corresponding to a separate value for each frequency band of the one or more frequency bands associated with the precoding matrix.

In some embodiments, the CBSR threshold comprises a null value, where the null value corresponds to a hard CBSR. In some embodiments, a value of the CBSR threshold is configured from a codebook of values of the CBSR threshold, the codebook of values comprising at least one non-zero value, where the non-zero value corresponds to a soft CBSR.

The controller 1206 may manage input and output signals for the NE 1200. The controller 1206 may also manage peripherals not integrated into the NE 1200. In some implementations, the controller 1206 may utilize an OS such as iOS®, ANDROID®, WINDOWS®, or other OSes. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., an LNA) configured to amplify the received signal. The receiver chain 1210 may include at least one demodulator configured to demodulate the receiving signal and obtain the transmitted data by reversing the modulation technique applied during transmission of the signal. The receiver chain 1210 may include at least one decoder for decoding and processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

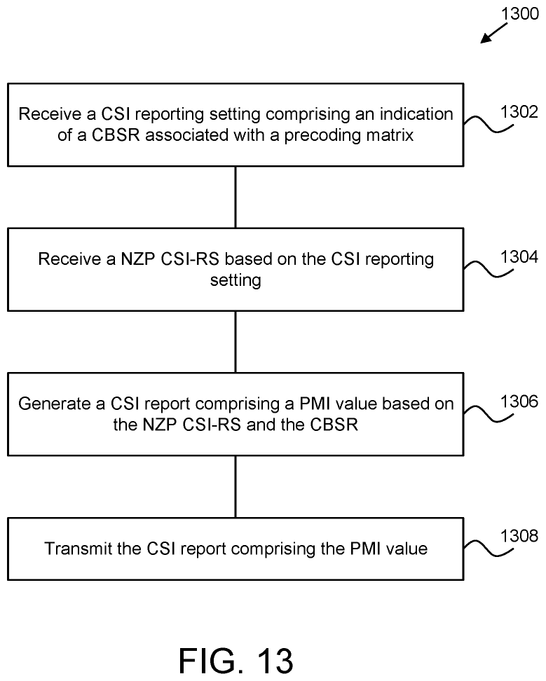

FIG. 13 illustrates a flowchart of a method 1300 in accordance with aspects of the present disclosure. The operations of the method 1300 may be implemented by a UE as described herein. In some implementations, the UE may execute a set of instructions to control the function elements of the UE to perform the described functions.

At Step 1302, the method 1300 may include receiving a CSI reporting setting comprising an indication of a CBSR associated with a precoding matrix. The operations of Step 1302 may be performed in accordance with examples as described herein. In some implementations, aspects of the operations of Step 1302 may be performed by a UE as described with reference to FIG. 10.

At Step 1304, the method 1300 may include receiving a NZP CSI-RS based on the CSI reporting setting. The operations of Step 1304 may be performed in accordance with examples as described herein. In some implementations, aspects of the operations of Step 1304 may be performed by a UE as described with reference to FIG. 10.

At Step 1306, the method 1300 may include generating a CSI report comprising a PMI value based on the NZP CSI-RS and the CBSR. The operations of Step 1306 may be performed in accordance with examples as described herein. In some implementations, aspects of the operations of Step 1306 may be performed by a UE as described with reference to FIG. 10.

At Step 1308, the method 1300 may include transmitting the CSI report comprising the PMI value. The operations of Step 1308 may be performed in accordance with examples as described herein. In some implementations, aspects of the operations of Step 1308 may be performed by a UE as described with reference to FIG. 10.

It should be noted that the method 1300 described herein describes one possible implementation, and that the operations and the steps may be rearranged or otherwise modified and that other implementations are possible.

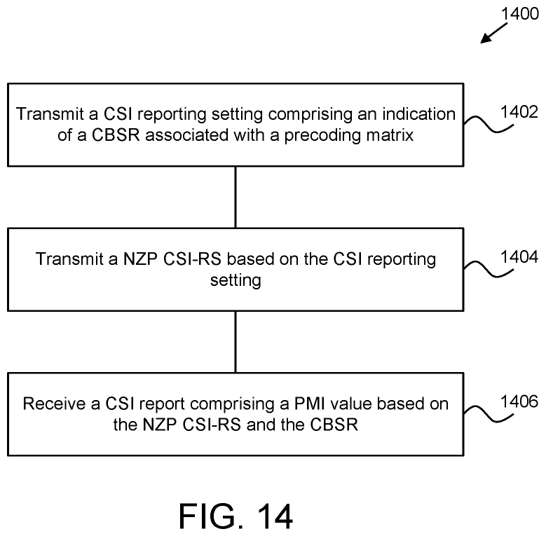

FIG. 14 illustrates a flowchart of a method 1400 in accordance with aspects of the present disclosure. The operations of the method 1400 may be implemented by a NE as described herein. In some implementations, the NE may execute a set of instructions to control the function elements of the NE to perform the described functions.

At Step 1402, the method 1400 may include transmitting a CSI reporting setting comprising an indication of a CBSR associated with a precoding matrix. The operations of Step 1402 may be performed in accordance with examples as described herein. In some implementations, aspects of the operations of Step 1402 may be performed by a NE as described with reference to FIG. 12.

At Step 1404, the method 1400 may include transmitting a NZP CSI-RS based on the CSI reporting setting. The operations of Step 1404 may be performed in accordance with examples as described herein. In some implementations, aspects of the operations of Step 1404 may be performed by a NE as described with reference to FIG. 12.

At Step 1406, the method 1400 may include receiving a CSI report comprising a PMI value based on the NZP CSI-RS and the CBSR. The operations of Step 1406 may be performed in accordance with examples as described herein. In some implementations, aspects of the operations of Step 1406 may be performed by a NE as described with reference to FIG. 12.

It should be noted that the method 1400 described herein describes one possible implementation, and that the operations and the steps may be rearranged or otherwise modified and that other implementations are possible.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a channel state information (CSI) reporting setting comprising an indication of a codebook subset restriction (CBSR) associated with a precoding matrix;
receive a non-zero power (NZP) CSI reference signal (CSI-RS) based on the CSI reporting setting;
generate a CSI report comprising a precoding matrix indicator (PMI) value based on the NZP CSI-RS and the CBSR; and
transmit the CSI report comprising the PMI value.

2. The UE of claim 1, wherein the CBSR comprises at least one of:
a set of restriction vectors configured by a radio access network (RAN) entity,
a CBSR metric that identifies a correlation value between a candidate precoding vector and the set of restriction vectors,
a CBSR threshold corresponding to the CBSR metric,
or a combination thereof.

3. The UE of claim 2, wherein the PMI value is associated with a set of precoding vectors, and wherein the at least one processor is configured to cause the UE to:
determine, using the CBSR metric, the correlation value between the candidate precoding vector and the set of restriction vectors; and
select the candidate precoding vector as an associated precoding vector of the set of associated precoding vectors based on the correlation value satisfying the CBSR threshold.

4. The UE of claim 3, wherein the correlation value satisfies the CBSR threshold based on the correlation value being less than or equal to the CBSR threshold.

5. The UE of claim 3, wherein the at least one processor is configured to cause the UE to:
apply the CBSR metric on each frequency band of one or more frequency bands associated with the precoding matrix.

6. The UE of claim 2, wherein the set of restriction vectors comprises a subset of precoding vectors corresponding to one or more discrete Fourier transform (DFT)-based matrices.

7. The UE of claim 6, wherein the one or more DFT-based matrices comprise a set of oversampled DFT matrices comprising one or more phase offsets corresponding to oversampling factors.

8. The UE of claim 2, wherein the set of restriction vectors comprises a subset of a pre-configured set of restriction vectors.

9. The UE of claim 8, wherein the at least one processor is configured to cause the UE to receive, from a radio access network (RAN) entity, an indication corresponding to the subset of the pre-configured set of restriction vectors.

10. The UE of claim 2, wherein the CBSR metric comprises a cosine-based similarity function.

11. The UE of claim 2, wherein the CBSR metric is based on a magnitude of a normalized standard auto-correlation function.

12. The UE of claim 2, wherein the CBSR metric is based on a square of a magnitude of a normalized standard auto-correlation function.

13. The UE of claim 2, wherein the CBSR metric is based on a wideband value corresponding to an averaged value across one or more frequency bands associated with the precoding matrix.

14. The UE of claim 2, wherein the CBSR metric is based on a per-band value corresponding to a separate value for each frequency band of the one or more frequency bands associated with the precoding matrix.

15. The UE of claim 2, wherein the CBSR threshold comprises a null value, and wherein the null value corresponds to a hard CBSR.

16. The UE of claim 2, wherein a value of the CBSR threshold is configured from a codebook of values of the CBSR threshold, wherein the codebook of values comprises at least one non-zero value, and wherein the non-zero value corresponds to a soft CBSR.

17. A method performed by a user equipment (UE), the method comprising:
receiving a channel state information (CSI) reporting setting comprising an indication of a codebook subset restriction (CBSR) associated with a precoding matrix;
receiving a non-zero power (NZP) CSI reference signal (CSI-RS) based on the CSI reporting setting;
generating a CSI report comprising a precoding matrix indicator (PMI) value based on the NZP CSI-RS and the CBSR; and
transmitting the CSI report comprising the PMI value.

18. A base station for wireless communication, comprising:
at least one memory; and
at least one processor coupled with the at least one memory and configured to cause the base station to:
transmit a channel state information (CSI) reporting setting comprising an indication of a codebook subset restriction (CBSR) associated with a precoding matrix;
transmit a non-zero power (NZP) CSI reference signal (CSI-RS) based on the CSI reporting setting; and
receive a CSI report comprising a precoding matrix indicator (PMI) value based on the NZP CSI-RS and the CBSR.

19. The base station of claim 18, wherein the CBSR comprises at least one of:
a set of restriction vectors,
a CBSR metric that identifies a correlation value between a candidate precoding vector and the set of restriction vectors,
a CBSR threshold corresponding to the CBSR metric,
or a combination thereof.

20. A method performed by a base station, the method comprising:
transmitting a channel state information (CSI) reporting setting comprising an indication of a codebook subset restriction (CBSR) associated with a precoding matrix;
transmitting a non-zero power (NZP) CSI reference signal (CSI-RS) based on the CSI reporting setting; and
receiving a CSI report comprising a precoding matrix indicator (PMI) value based on the NZP CSI-RS and the CBSR.
